(19) United States
(12) Patent Application Publication
(10) Pub. No.: US 2022/0012535 A1
(43) Pub. Date: Jan. 13, 2022

(54) Augmenting Training Data Sets for ML Classifiers Using Classification Metadata

(71) Applicant: VMware, Inc., Palo Alto, CA (US)

(72) Inventors: Yaniv Ben-Itzhak, Afek (IL); Shay Vargaftik, Nazareth-Illit (IL)

(21) Appl. No.: 16/924,009

(22) Filed: Jul. 8, 2020

(51) Int. Cl. G06K 9/62; G06N 20/00

(52) U.S. Cl. CPC G06K 9/6257; G06N 20/00; G06K 9/623

(57) ABSTRACT

Techniques for augmenting training data sets for machine learning (ML) classifiers using classification metadata are provided. In one set of embodiments, a computer system can train a first ML classifier using a training data set, where the training data set comprises a plurality of data instances, where each data instance includes a set of features, and where the training results in a trained version of the first ML classifier. The computer system can further classify each data instance in the plurality of data instances using the trained version of the first ML classifier, the classifications generating classification metadata for each data instance, and augment the training data set with the classification metadata to create an augmented version of the training data set. The computer system can then train a second ML classifier using the augmented version of the training data set.

### BACKGROUND

In machine learning (ML), classification is the task of predicting, from among a plurality of predefined categories (i.e., classes), the class to which a given data instance belongs. An ML model that implements classification is referred to as an ML classifier. Examples of well-known types of supervised ML classifiers include random forest, adaptive boosting, and gradient boosting, and an example of a well-known type of unsupervised ML classifier is isolation forest.

ML classifiers are often employed in use cases/applications where high classification accuracy is important (e.g., identifying fraudulent financial transactions, network security monitoring, detecting faults in safety-critical systems, etc.). Accordingly, techniques that can improve the performance of ML classifiers are highly desirable.

### BRIEF DESCRIPTION OF THE DRAWINGS

FIG. 1 depicts a conventional training process for an ML classifier.

FIG. 2 depicts a first training process for an ML classifier that makes use of classification metadata according to certain embodiments.

FIG. 3 depicts a second training process for an ML classifier that makes use of classification metadata according to certain embodiments.

FIG. 4 depicts a workflow of the training process of FIG. 2 according to certain embodiments.

FIG. 5 depicts a workflow of the training process of FIG. 3 according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques for augmenting the training data set for an ML classifier (e.g., M₁) via metadata that is generated by another, different ML classifier (e.g., M₂) at the time of classifying data instances in that data set. As used herein, “augmenting” the training data set refers to adding one or more additional features to each data instance in the training data set based on the metadata generated by ML classifier M₂. Such metadata can include, e.g., the classification and associated confidence level output by ML classifier M₂ for each data instance.

Once the training data set has been augmented as described above, the augmented training data set can be used to train ML classifier M₁, thereby improving the performance of M₁ by virtue of the additional features derived from ML classifier M₂. In one set of embodiments, the entirety of the augmented training data set may be used to train ML classifier M₁. In another set of embodiments, a subset of the augmented training data set may be selected according to one or more criteria and the selected subset may be used to train ML classifier M₁, thus reducing the training time for M₁.

The foregoing and other aspects of the present disclosure are described in further detail below.

### 2. High-Level Solution Description

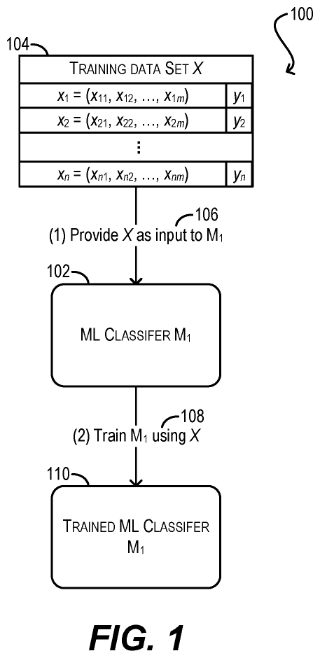

To provide context for the embodiments presented herein, FIG. 1 depicts a conventional process 100 for training an ML classifier M₁ (reference numeral 102) using a training data set X (reference numeral 104) comprising n data instances. Each data instance i for =1 . . . n in X includes a feature set xᵢ comprising m features (xᵢ₁, xᵢ₂, . . . , xᵢₘ). Each feature can be understood as an attribute of its corresponding data instance and will generally have a continuous (e.g., real/integer) or discrete (e.g., categorical) value. In this example, ML classifier M₁ is assumed to implement a supervised classification algorithm (e.g., random forest, adaptive boosting, gradient boosting, etc.) and thus each data instance i further includes a label yᵢ indicating the correct class for feature set xᵢ/data instance i. For instance, with respect to data instance 1, the correct class for feature set x₁ is identified by label y₁. In scenarios where ML classifier M₁ implements an unsupervised classification algorithm (e.g., isolation forest, etc.), training data set X will not include any labels for its data instances—in other words, each data instance i will only comprise feature set xᵢ without label yᵢ.

At step (1) of process 100 (reference numeral 106), training data set X is provided as input to ML classifier M₁. At step (2) (reference numeral 108), ML classifier M₁ is trained using training data set X The details of this training will differ depending on the type of ML classifier M₁, but in general the training entails configuring/building ML classifier M₁ in a manner that enables the classifier to correctly predict label yᵢ for each data instance i in training data set X. Once ML classifier M₁ is trained using training data set X, a trained version of ML classifier M₁ (reference numeral 110) is generated.

While conventional training process 100 of FIG. 1 is functional, different types of ML classifiers exhibit different strengths and weaknesses during training that can affect their classification accuracy. For example, boosting method (e.g., adaptive boosting and gradient boosting) classifiers are strong at capturing complex dependencies in training data sets but are prone to over-fitting the training data. In contrast, bagging method (e.g., random forest) classifiers are less adept at capturing complex dependencies but generally will not over-fit the training data. Thus, it would be useful to have training techniques that can merge the strengths of different types of ML classifiers into a single classifier.

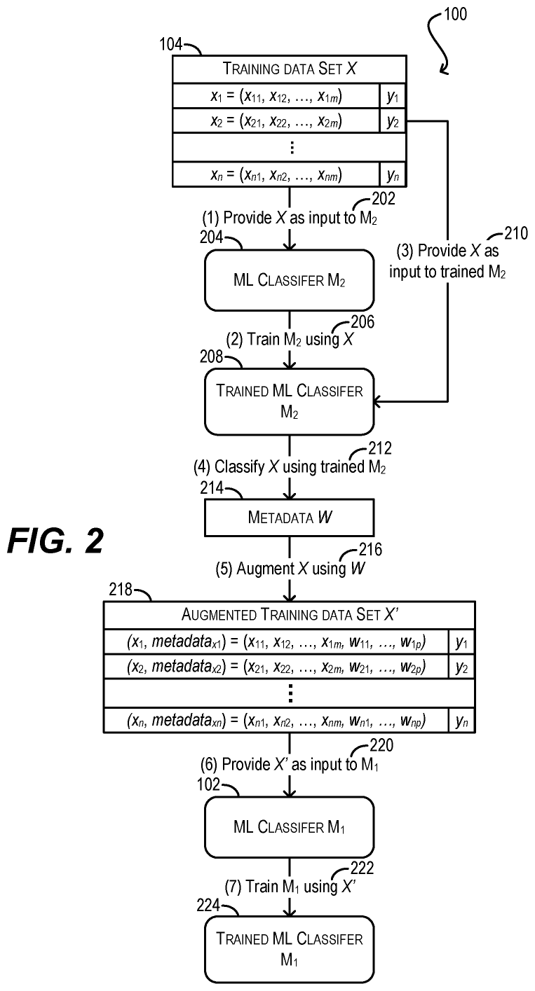

FIG. 2 depicts a novel training process 200 that accomplishes this goal with respect to ML classifier M₁ according to certain embodiments. At step (1) of process 200 (reference numeral 202), training data set X is provided as input to an ML classifier M₂ (reference numeral 204), where M₂ is a different classifier (and in some embodiments, is a different classifier type) than ML classifier M₁. For example, ML classifier M₂ may be a boosting method classifier while ML classifier M₁ may be a bagging method classifier.

At step (2) (reference numeral 206), ML classifier M₂ is trained using training data set X, resulting in a trained version of M₂ (reference numeral 208). Training data set X is then provided as input to trained ML classifier M₂ (step (3); reference numeral 210) and trained ML classifier M₂ classifies the data instances in X (step (4); reference numeral 212), thereby generating metadata W comprising p metadata values w₁ . . . wₚ for each data instance i in X arising out of the classification process (reference numeral 214).

For example, in one set of embodiments, metadata W can include the predicted classification and associated confidence level output by trained ML classifier M₂ for each data instance. In other embodiments, metadata W can include other types of classification-related information, such as the full class distribution vector generated by trained ML classifier M₂ (in the case where M₂ is a random forest classifier), the number of trees in trained ML classifier M₂ that voted for the predicted classification (in the case where M₂ is a tree-based ensemble method classifier), and so on.

At step (5) (reference numeral 216), training data set X is augmented using metadata W, resulting in augmented training data set X′ (reference numeral 218). As shown, augmented training data set X′ includes, for feature set xᵢ of each data instance i, an additional set of metadata values metadataₓ_{ᵢ} comprising values wᵢ_{₁} to wᵢₚ. Finally, augmented training data set X′ is provided as input to ML classifier M₁ (step (6); reference numeral 220) and M₁ is trained using X′ (step (7); reference numeral 222), resulting in a trained version of M₁ (reference numeral 224). Trained ML classifier M₁ can thereafter be used, either alone or in collaboration with trained ML classifier M₂, to classify unknown (i.e., query) data instances.

With the training process shown in FIG. 2, the classification accuracy of trained ML classifier M₁ can be advantageously improved in comparison to the conventional training process of FIG. 1. This is because trained ML classifier M₁ is influenced by the classification results generated by ML classifier M₂ via the inclusion of classification metadata W in augmented training data set X′. In the case where ML classifiers M₁ and M₂ are different types of classifiers, this allows trained ML classifier M₁ to effectively incorporate the strengths of each classifier type. Further, even in scenarios where ML classifiers M₁ and M₂ are different instances of the same classifier type, the approach shown in FIG. 2 enables trained ML classifier M₁ to learn from the results of trained ML classifier M₂, thereby resulting in potentially better performance.

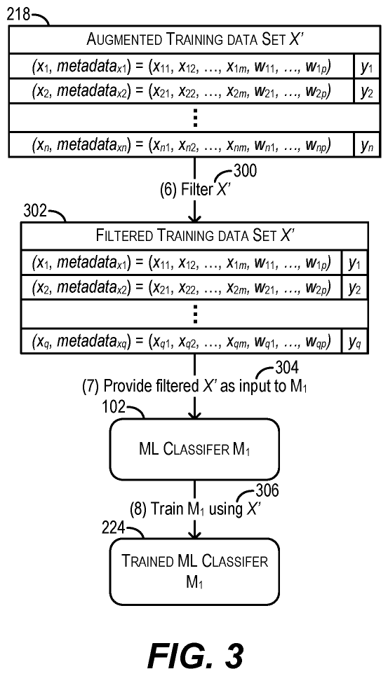

In some embodiments, rather than using the entirety of augmented training data set X′ to train ML classifier M₁ per step (6) of process 200, X′ can be filtered and thus reduced in size from n data instances to q data instances, where q<n. The filtered version of augmented training data set X′ can then be provided as input to ML classifier M₁ for training. This approach is depicted via alternative steps (6)-(8) (reference numerals 300-306) in FIG. 3. One advantage of filtering augmented training data set X′ in this manner is that the amount of time needed to train ML classifier M₁ can be reduced, which may be significant if M₁ is more complex than ML classifier M₂ of if the size of training data set X is very large.

The particular criterion or criteria used for filtering augmented training data set X′ can vary depending on the implementation (a number of examples are presented in section (3) below). However, in certain embodiments this filtering step can remove a higher percentage of training data instances that were deemed “easy” by trained ML classifier M₂ (i.e., those training data instances that M₂ was able to classify with a high degree of confidence), while keeping a higher percentage of training data instances that were deemed “difficult” by trained ML classifier M₂ (i.e., those training data instances that M₂ could not classify with a high degree of confidence). By removing a larger number of easy data instances and consequently keeping a larger number of difficult data instances, the size of the training data set can be reduced without meaningfully affecting the accuracy of trained ML classifier M₁.

It should be appreciated that processes 200 and 300 of FIGS. 2 and 3 are illustrative and not intended to limit embodiments of the present disclosure. For example, although process 200 depicts a scenario in which the training data set for ML classifier M₁ is augmented with classification metadata generated by a single other ML classifier M₂, in some embodiments the training data set for ML classifier M₁ may be augmented with classification metadata generated by multiple other classifiers (e.g., M₂, M₃, etc.). This multi-level augmentation may be performed iteratively (such that training data set X is first augmented by M₂ to generate augmented data set X′, which is then augmented by M₃ to generate further augmented data set X″, which is finally used to train M₁), or concurrently (such that training data set X is augmented with metadata from both M₂ and M₃ to generate augmented training data set X′, which is then used to train M₁).

Further, although processes 200 and 300 assume that training data sets X and X′ are labeled data sets (i.e., they include label column y) and thus ML classifiers M₁ and M₂ are supervised classifiers, in other embodiments one or both of M₁ and M₂ may be unsupervised classifiers (such as an isolation forest classifier). In these embodiments, training data set X and/or augmented training data set X′ may comprise unlabeled data instances. One of ordinary skill in the art will recognize other variations, modifications, and alternatives.

### 3. Workflows

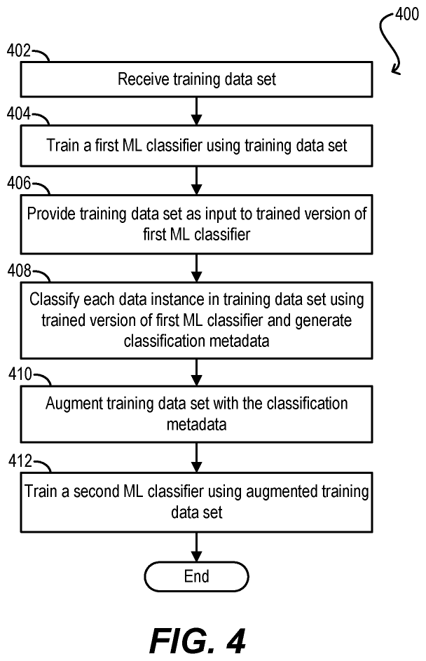

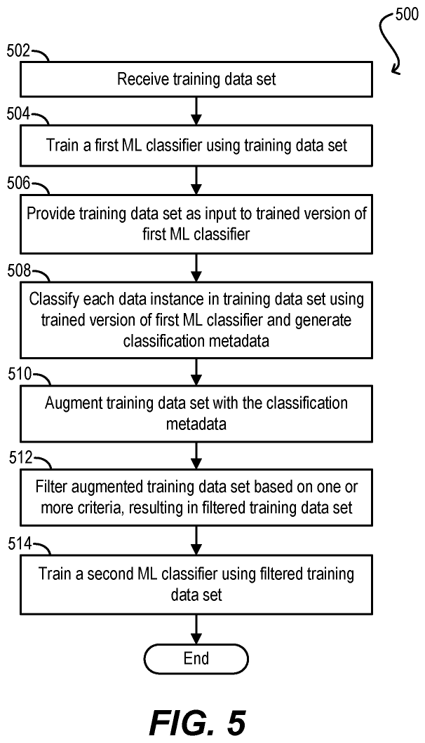

FIGS. 4 and 5 depict workflows 400 and 500 that present, in flowchart form, the training processes illustrated in FIGS. 2 and 3 respectively according to certain embodiments. As used herein, a “workflow” is a series of actions or steps that may be taken by one or more entities. For purposes of explanation, it is assumed that workflows 400 and 500 are each performed by a single physical or virtual computing device/system, such as a server in a cloud deployment, a user-operated client device, and edge device in an edge computing network, etc. However, in alternative embodiments different portions of these workflows may be performed by different computing devices/systems. For example, with respect to workflow 400, the training of the first ML classifier, the creation of the augmented training data set, and the training of the second ML classifier may be executed by first, second, and third devices/systems respectively.

Starting with blocks 402 and 404 of workflow 400, a computing device/system can receive a training data set (e.g., training data set X of FIG. 2) and train a first ML classifier (e.g., ML classifier M₂ of FIG. 2) using the training data set. As mentioned previously, this training data set can include labeled data instances (in the case where the first ML classifier is a supervised classifier) or unlabeled data instances (in the case where the first ML classifier is an unsupervised classifier). The result of the training at block 404 is a trained version of the first ML classifier.

At blocks 406 and 408, the computing device/system can provide the training data set as input to the trained first ML classifier and the trained first ML classifier can classify each data instance in the training data set. As part of block 408, the trained first ML classifier can generate metadata arising out of the classification of each data instance. This metadata can include, e.g., the predicted classification and confidence level for the data instance, the confidence levels of other classes that were not chosen as the predicted classification, etc.

At block 410, the computing device/system can augment the training data set to include the classification metadata generated at block 408. For example, for each data instance i in the training data set, the computing device/system can add one or more new features to the feature set of data instance i corresponding to the metadata generated for i.

Finally, at block 412, the computing device/system can train a second ML classifier (e.g., ML classifier M₁ of FIG. 2) using the augmented training data set, resulting in a trained version of the second ML classifier. This second ML classifier may be the same type or a different type of classifier as the first ML classifier. The trained second ML classifier can subsequently be used, potentially in conjunction with the trained first ML classifier, to classify unknown data instances.

Turning now to workflow 500 of FIG. 5, blocks 502-510 are substantially similar to blocks 402-410 of workflow 400. For example, at blocks 502 and 504, a computing device/system can receive a training data set and train a first ML classifier using that data set. The computing device/system can then provide the training data set as input to the trained first ML classifier (block 506), the trained first ML classifier can classify each data instance in the training data set, thereby generating associated classification metadata (block 508), and the computing device/system can create an augmented version of the training data set that includes the metadata generated at block 508 (block 510).

At block 512, the computing device/system can filter the data instances in the augmented training data set created at block 510, thereby generating a filtered (i.e., reduced) augmented training data set. In certain embodiments, this filtering step can involve randomly sampling data instances in the augmented training data set and, for each sampled data instance, determining whether the data instance meets one or more criteria; if the answer is yes, the data instance can have a higher likelihood of being added to the filtered data set. However if the answer is no, the data instance can have a higher probability of being discarded. This can continue until a target number or percentage of data instances have been added to the filtered data set (e.g., 10% of the total number of data instances).

One example criterion that may be applied to each data instance for the filtering at block 512 is whether the confidence level of the prediction generated by the first ML classifier is less than a confidence threshold; if so, that means the data instance was relatively difficult for the first ML classifier to classify and thus should have a high chance of being added to the filtered data set. Another example criterion is whether the variance of per-class probabilities generated by the first ML classifier for the data instance (in the case where the first classifier is, e.g., a random forest classifier) is less than a variance threshold; if so, this also indicates that the data instance was relatively difficult for the first ML classifier to classify and thus should have a high chance of being added to the filtered data set.

Finally, upon filtering the augmented training data set, the computing device/system can train a second ML classifier (e.g., ML classifier M₁ of FIG. 2) using the filtered training data set, resulting in a trained version of the second ML classifier (block 514). In one set of embodiments, the filtered data set used to train the second ML classifier may include all of the metadata added to the augmented training data set at block 510. In other embodiments, some or all of that metadata may be excluded from the filtered training data set at the time of training the second ML classifier.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments, and are presented to illustrate the flexibility and advantages of particular embodiments as defined by the following claims. Other arrangements, embodiments, implementations and equivalents can be employed without departing from the scope hereof as defined by the claims.

What is claimed is:

1. A method comprising:
training, by a computer system, a first machine learning (ML) classifier using a training data set, wherein the training data set comprises a plurality of data instances, wherein each data instance includes a set of features, and wherein the training results in a trained version of the first ML classifier;
classifying, by the computer system, each data instance in the plurality of data instances using the trained version of the first ML classifier, the classifying generating classification metadata for each data instance;
augmenting, by the computer system, the training data set with the classification metadata to create an augmented version of the training data set; and
training, by the computer system, a second ML classifier using the augmented version of the training data set.

2. The method of claim 1 wherein the classification metadata for each data instance includes one or more metadata values, and wherein augmenting the training data set with the classification metadata comprises, for each data instance in the plurality of data instances:
adding the one or more metadata values to the data instance's set of features.

3. The method of claim 1 wherein the classification metadata for each data instance includes a classification result determined by the first ML classifier for the data instance and a confidence level associated with the classification result.

4. The method of claim 1 wherein the second ML classifier is a different type of ML classifier than the first ML classifier.

5. The method of claim 1 wherein the augmented version of the training data set is filtered prior to training the second ML classifier.

6. The method of claim 5 wherein the augmented version of the training data set is filtered by:
randomly sampling a data instance in the augmented version of the training data set;
determining whether the sampled data instance meets one or more criteria, the one or more criteria being based on the classification metadata;
if the sampled data instance fails to meet one or more criteria, causing the sampled data instance to be removed from the augmented version of the training data set with a relatively high likelihood.

7. The method of claim 6 wherein the one or more criteria include a criterion indicating that a confidence level associated with a classification result generated by the first ML classifier for the sampled data instance is lower than a confidence threshold.

8. A non-transitory computer readable storage medium having stored thereon program code executable by a computer system, the program code causing the computer system to execute a method comprising:
training a first machine learning (ML) classifier using a training data set, wherein the training data set comprises a plurality of data instances, wherein each data instance includes a set of features, and wherein the training results in a trained version of the first ML classifier;
classifying each data instance in the plurality of data instances using the trained version of the first ML classifier, the classifying generating classification metadata for each data instance;
augmenting the training data set with the classification metadata to create an augmented version of the training data set; and
training a second ML classifier using the augmented version of the training data set.

9. The non-transitory computer readable storage medium of claim 8 wherein the classification metadata for each data instance includes one or more metadata values, and wherein augmenting the training data set with the classification metadata comprises, for each data instance in the plurality of data instances:
adding the one or more metadata values to the data instance's set of features.

10. The non-transitory computer readable storage medium of claim 8 wherein the classification metadata for each data instance includes a classification result determined by the first ML classifier for the data instance and a confidence level associated with the classification result.

11. The non-transitory computer readable storage medium of claim 8 wherein the second ML classifier is a different type of ML classifier than the first ML classifier.

12. The non-transitory computer readable storage medium of claim 8 wherein the augmented version of the training data set is filtered prior to training the second ML classifier.

13. The non-transitory computer readable storage medium of claim 12 wherein the augmented version of the training data set is filtered by:
randomly sampling a data instance in the augmented version of the training data set;
determining whether the sampled data instance meets one or more criteria, the one or more criteria being based on the classification metadata;
if the sampled data instance fails to meet one or more criteria, causing the sampled data instance to be removed from the augmented version of the training data set with a relatively high likelihood.

14. The non-transitory computer readable storage medium of claim 13 wherein the one or more criteria include a criterion indicating that a confidence level associated with a classification result generated by the first ML classifier for the sampled data instance is lower than a confidence threshold.

15. A computer system comprising:
a processor; and
a non-transitory computer readable medium having stored thereon program code that, when executed, causes the processor to:
train a first machine learning (ML) classifier using a training data set, wherein the training data set comprises a plurality of data instances, wherein each data instance includes a set of features, and wherein the training results in a trained version of the first ML classifier;
classify each data instance in the plurality of data instances using the trained version of the first ML classifier, the classifying generating classification metadata for each data instance;
augment the training data set with the classification metadata to create an augmented version of the training data set; and
train a second ML classifier using the augmented version of the training data set.

16. The computer system of claim 15 wherein the classification metadata for each data instance includes one or more metadata values, and wherein the program code that causes the processor to augment the training data set with the classification metadata comprises code that causes the processor to, for each data instance in the plurality of data instances:
add the one or more metadata values to the data instance's set of features.

17. The computer system of claim 15 wherein the classification metadata for each data instance includes a classification result determined by the first ML classifier for the data instance and a confidence level associated with the classification result.

18. The computer system of claim 15 wherein the second ML classifier is a different type of ML classifier than the first ML classifier.

19. The computer system of claim 15 wherein the augmented version of the training data set is filtered prior to training the second ML classifier.

20. The computer system of claim 19 wherein the augmented version of the training data set is filtered by:
randomly sampling a data instance in the augmented version of the training data set;
determining whether the sampled data instance meets one or more criteria, the one or more criteria being based on the classification metadata;
if the sampled data instance fails to meet one or more criteria, causing the sampled data instance to be removed from the augmented version of the training data set with a relatively high likelihood.

21. The computer system of claim 20 wherein the one or more criteria include a criterion indicating that a confidence level associated with a classification result generated by the first ML classifier for the sampled data instance is lower than a confidence threshold.
